(19) United States
(12) Patent Application Publication
(10) Pub. No.: US 2023/0230035 A1
(43) Pub. Date: Jul. 20, 2023

(54) Method and Apparatus for Constructing Organizational Collaboration Network

(71) Applicant: Beijing Baidu Netcom Science Technology Co., Ltd., Beijing (CN)

(72) Inventors: Peng WANG, Beijing (CN); Zheng DONG, Beijing (CN); Hengshu ZHU, Beijing (CN); Xin SONG, Beijing (CN); Jing WANG, Beijing (CN); Jingshuai ZHANG, Beijing (CN)

(21) Appl. No.: 17/940,544

(22) Filed: Sep. 8, 2022

(30) Foreign Application Priority Data
Jan. 19, 2022 (CN) 202210061719.0

(51) Int. Cl. G06Q 10/10; G06K 9/62

(52) U.S. Cl. CPC G06Q 10/101; G06K 9/6276; G06K 9/6272; G06K 9/6215; G06Q 50/01

(57) ABSTRACT

The present disclosure provides a method and apparatus for constructing an organizational collaboration network, and relates to the field of artificial intelligence, and particularly to the field of big data analysis. A specific implementation includes: acquiring collaborative data between at least one pair of organizations; calculating at least one collaboration index between each pair of organizations according to the collaborative data; calculating, for each pair of organizations, a degree of closeness between the pair of organizations according to a weighted sum of the at least one collaboration index between the pair of organizations; and using each organization as a node, a relationship between each pair of organizations as an edge, and the degree of closeness between each pair of organizations as a weight of the edge, to construct the organizational collaboration network.

### CROSS-REFERENCE TO RELATED APPLICATIONS

The present application claims priority to Chinese Patent Application No. CN202210061719.0, filed with the China National Intellectual Property Administration on Jan. 19, 2022, the disclosure of which is herein incorporated by reference in its entirety.

### TECHNICAL FIELD

The present disclosure relates to the field of artificial intelligence, particularly the field of big data analysis, and specifically to a method and apparatus for constructing an organizational collaboration network.

### BACKGROUND

With a continuously increasing scale of an enterprise, and the number of organizations within the enterprise growing, business organizations become increasingly specialized and a an organizational structure of the enterprise becomes extremely complex. Therefore, effective collaboration between different business organizations is vital to the success of the enterprise. Based on existing online collaborative data, an organizational collaboration network can be scientifically constructed, which helps to quantitatively evaluate an organizational collaboration relationship, an organizational collaboration abnormality, and provide an organizational collaboration efficiency analysis.

### SUMMARY

The present disclosure provides a method and apparatus for constructing an organizational collaboration network, a device, a storage medium and a computer program product.

In a first aspect, embodiments of the present disclosure provide a method for constructing an organizational collaboration network, comprising: acquiring collaborative data between at least one pair of organizations; calculating at least one collaboration index between each pair of organizations according to the collaborative data; calculating, for each pair of organizations, a degree of closeness between the pair of organizations according to a weighted sum of the at least one collaboration index between the pair of organizations; and using each organization as a node, a relationship between each pair of organizations as an edge, and the degree of closeness between each pair of organizations as a weight of the edge, to construct the organizational collaboration network.

In a second aspect, embodiments of the present disclosure provide an apparatus for constructing an organizational collaboration network, comprising: an acquiring unit, configured to acquire collaborative data between at least one pair of organizations; a first calculating unit, configured to calculate at least one collaboration index between each pair of organizations according to the collaborative data; a second calculating unit, configured to calculate, for each pair of organizations, a degree of closeness between the pair of organizations according to a weighted sum of the at least one collaboration index between the pair of organizations; and a constructing unit, configured to use each organization as a node, a relationship between each pair of organizations as an edge, and the degree of closeness between each pair of organizations as a weight of the edge, to construct the organizational collaboration network.

In a third aspect, embodiments of the present disclosure provide an electronic device, comprising: one or more processors; and a memory, storing one or more programs, wherein the one or more programs, when executed by the one or more processors, cause the one or more processors to implement the method provided by the first aspect.

In a fourth aspect, embodiments of the present disclosure provide a computer-readable medium, storing a computer program thereon, wherein the program, when executed by a processor, causes the processor to implement the method provided by the first aspect.

In a fifth aspect, an embodiment of the present disclosure provides a computer program product, comprising a computer program, wherein the computer program, when executed by a processor, implements the method provided by the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure. Here:

FIG. 1 is a diagram of an exemplary system architecture in which an embodiment of the present disclosure may be applied;

FIG. 2 is a flowchart of an embodiment of a method for constructing an organizational collaboration network according to the present disclosure;

FIG. 3 is a flowchart of another embodiment of the method for constructing an organizational collaboration network according to the present disclosure;

FIG. 4 is a schematic diagram of visualization of an organizational collaboration network in the method for constructing an organizational collaboration network according to the present disclosure;

FIG. 5 is a schematic structural diagram of an apparatus for constructing an organizational collaboration network according to the present disclosure; and

FIG. 6 is a schematic structural diagram of a computer system of an electronic device adapted to implement the embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

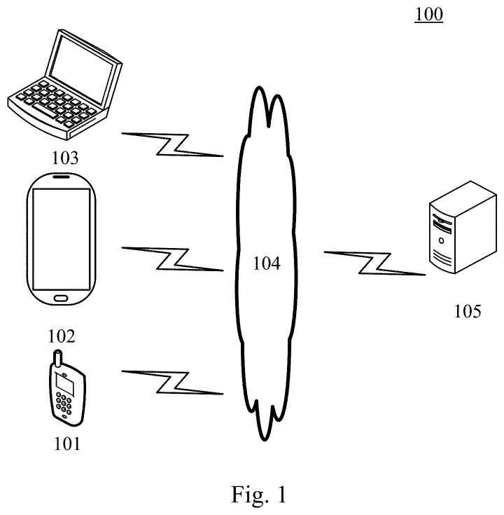

FIG. 1 illustrates an exemplary system architecture 100 in which an embodiment of a method for constructing an organizational collaboration network or apparatus for constructing an organizational collaboration network according to the present disclosure may be applied.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, for example, wired or wireless communication links, or optical fiber cables.

A user may use the terminal devices 101, 102 and 103 to interact with the server 105 via the network 104 to receive or send messages, etc. Various communication client applications (a project management application, a meeting record application, a webpage browser application, a shopping application, a search application, an instant communication tool, an email client, and social platform software) may be installed on the terminal devices 101, 102 and 103.

The terminal devices 101, 102 and 103 may be hardware or software. When being the hardware, the terminal devices 101, 102 and 103 may be various electronic devices having a display screen and supporting webpage browsing, the electronic devices including, but not limited to, a smart phone, a tablet computer, an e-book reader, and an MP3 player (moving picture experts group audio layer III), an MP4 (moving picture experts group audio layer IV) player, a laptop portable computer, a desktop computer, and the like. When being the software, the terminal devices 101, 102 and 103 may be installed in the listed electronic devices. The terminal devices 101, 102 and 103 may be implemented as a plurality of pieces of software or a plurality of software modules (e.g., software or software modules for providing a distributed service), or as a single piece of software or a single software module, which will not be specifically limited here.

The server 105 may be a server providing various services. For example, the server 105 may be a backend webpage server providing support for a webpage displayed on the terminal devices 101, 102 and 103. The backend webpage server may perform processing such as an analysis on received data such as a collaborative data analysis request, and feed back the processing result (e.g., an organizational collaboration network) to the terminal devices.

It should be noted that the server may be hardware or software. When being the hardware, the server may be implemented as a distributed server cluster composed of a plurality of servers, or may be implemented as a single server. When being the software, the server may be implemented as a plurality of pieces of software or a plurality of software modules (e.g., software or software modules for providing a distributed service), or may be implemented as a single piece of software or a single software module, which will not be specifically defined here. The server may alternatively be a server of a distributed system, or a server combined with a blockchain. The server may alternatively be a cloud server, or an intelligent cloud computing server or intelligent cloud host with the artificial intelligence technology.

It should be noted that the method for constructing an organizational collaboration network provided in the embodiments of the present disclosure is generally performed by the server 105, and correspondingly, the apparatus for constructing an organizational collaboration network is generally provided in the server 105.

It should be appreciated that the numbers of the terminal devices, the networks, and the servers in FIG. 1 are merely illustrative. Any number of terminal devices, networks, and servers may be provided based on actual requirements.

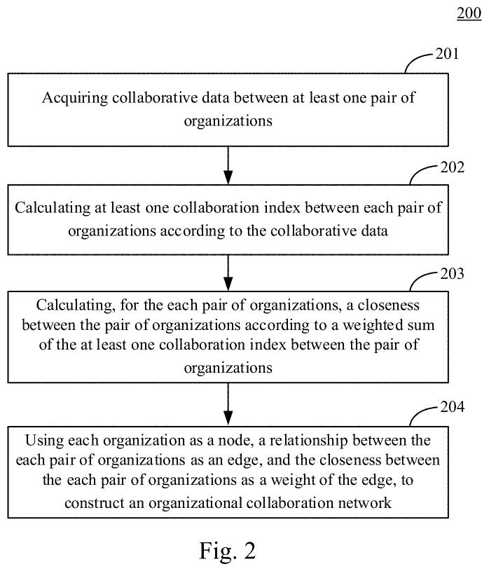

Further referring to FIG. 2, FIG. 2 illustrates a flow 200 of an embodiment of a method for constructing an organizational collaboration network according to the present disclosure. The method for constructing an organizational collaboration network includes the following steps:

Step 201, acquiring collaborative data between at least one pair of organizations.

In this embodiment, an executing body (e.g., the server shown in FIG. 1) of the method for constructing an organizational collaboration network may acquire the collaborative data between the at least one pair of organizations by means of a wired connection or a wireless connection. The organizations here may refer to internal departments of a company or departments of different companies. The collaborative data may include offline collaborative data and online collaborative data, for example, an online mail and instant messaging (IM) collaboration log, an offline meeting collaboration log, and a project collaborative management log.

Step 202, calculating at least one collaboration index between each pair of organizations according to the collaborative data.

In this embodiment, the following collaboration evaluation indices are respectively calculated:

First, for online collaborative mails and IM, the following indices between two organizations are respectively calculated: 1) a number of collaborations (the number is increased by 1 for each mail sent, and the number is increased by 1 for each IM message sent), 2) a number of people in the collaborations (a total number of mail recipients and senders, and a total number of IM message senders and recipients), and 3) a number of days for the collaborations (the number of the days for the collaborations is increased by 1 as long as at least one mail is received or one IM message is sent in one day). For IM data, a conversation number index is added, and one conversation can be considered as one complete collaborative process for a certain piece of work. The method of calculating a number of conversations refers to that if the time interval between the time at which both parties send and receive a message is not more than 20 minutes, it is considered that the conversation is continued and not ended, otherwise, it is considered that a new conversation starts.

Next, for offline collaborative meetings, the following indices between two organizations are respectively calculated: 1) a number of meetings, 2) a duration of the meetings (a total duration of all the meetings), 3) an average number of participants in each meeting (a number of participants of the two organizations in all the meetings/the number of the meetings), and 4) a number of days for the meetings (a cumulative number of the days for the meetings). Some meetings may be attended by a plurality of organizations, and for any two of these organizations, a number of collaborations is increased by 1. An organization with more participants plays a more important role in a collaboration.

Finally, for project collaborations, the following indices between two organizations are respectively calculated: 1) a number of collaborative projects, 2) a number of collaborations (the number is increased by 1 for each project management action), 3) a number of people in the collaborations (a number of participants in a designated project), and 4) a number of days for the collaborations (a number of days for a project cooperation). The statistical method of these indices is the same as that of the mail indices, and thus will not be repeatedly described. A project collaboration is defined as one management action in a project management system, for example, a project demand application, a project development/test, and a project operation. A project cooperation is often a cooperation among a plurality of organizations, and it can be determined which organizations undertake more work in a project according to an amount of collaboration.

Step 203, calculating, for each pair of organizations, a degree of closeness between the pair of organizations according to a weighted sum of the at least one collaboration index between the pair of organizations.

In this embodiment, through the above calculations, collaboration indices between each organization and other organizations under over a dozen dimensions are respectively obtained. For each pair of organizations, according to preset weights of different collaboration indices, the weighted sum of the collaboration indices may be calculated as the degree of closeness between the organizations.

Step 204, using each organization as a node, a relationship between each pair of organizations as an edge, and the degree of closeness between each pair of organizations as a weight of the edge, to construct an organizational collaboration network.

In this embodiment, according to the collaborative closeness relationship between the organizations that is calculated in the previous step, the organizations are used as nodes, the relationship between each pair of organizations is used as the edge, and the closeness is used as the weight of the edge, to construct the organizational collaboration network.

According to the method provided in the above embodiment of the present disclosure, effective organizational collaboration evaluation indices are constructed based on the online organizational collaboration data, and a model is constructed to learn the weight of each index, thus realizing the quantitative evaluation for the degree of closeness of the collaboration between the organizations, and an organizational collaboration relationship network is finally constructed. Accordingly, the limitations of traditional manual methods of organizational collaboration evaluation are effectively solved, reducing the labor input costs, and an organizational collaboration relationship network can be automatically generated in real time.

In some alternative implementations of this embodiment, the calculating at least one collaboration index between each pair of organizations according to the collaborative data includes: generating, by each organization, one numerical value list for each collaboration dimension, the numerical value list representing collaboration index values of all organizations collaborating with the organization; and arranging the numerical value list of each organization in a descending order to obtain a ranking result, and normalizing the ranking result to obtain the at least one collaboration index between each pair of organizations.

For each dimension, each organization generates one numerical value list, which represents the collaboration index values of all the organizations collaborating with each organization. Then, the numerical value list is arranged in a descending order to obtain a ranking result rᵢⱼ^{k} of each value in the list, and then the ranking is normalized to obtain \hat{r}ᵢⱼ^{k}=(Nᵢ^{k}−rᵢⱼ^{k}+0.1)/Nᵢ^{k}.

Here, rᵢⱼ^{k} represents a ranking of a j-th organization in an i-th organization collaboration list under a k-th dimension, and Nᵢ^{k} represents a number of organizations collaborating with an i-th organization under the k-th dimension, k e K representing a number of dimensions.

In this way, the collaboration indices under different dimensions can be compared horizontally, and thus will be more scientific and reasonable.

In some alternative implementations of this embodiment, the calculating, for each pair of organizations, a degree of closeness between the pair of organizations according to a weighted sum of the at least one collaboration index between the pair of organizations includes: calculating, for each pair of organizations, a mean value of each collaboration index between the pair of organizations, and calculating a difference of square of each collaboration index according to the mean value of each collaboration index; optimizing a target function through a stochastic gradient descent algorithm to obtain a weight of each collaboration index, the target function being aimed to minimize a weighted sum of the difference of square of each collaboration index; and calculating the degree of closeness between each pair of organizations according to the weight.

The present disclosure provides an unsupervised learning algorithm of combining any number of indices into one index. The general idea is to calculate the mean value according to the normalized value of the ranking value of each index in the previous step, and then calculate the difference between each index and the mean value. The idea is to assign a larger weight value to a “majority consensus index,” and a smaller weight value to a “minority index disagreeing with the majority index.” The weight value of each index is iteratively synthesized through the stochastic gradient descent algorithm, and a weighted sum is performed after the weight value is obtained, to obtain one final index value.

It is assumed that N indices mᵢ(i=1, . . . , N) are combined into one index m. The purpose of the present disclosure is to learn N weights wᵢ(i=1, . . . , N) through the unsupervised learning algorithm, representing the weight occupied by each index. At the same time, the constraint is Σᵢ₌₀^{N}wᵢ=1. After an assigned specific weight is obtained, the final composite index is:

m=Σᵢ₌₀^{N}wᵢmᵢ.

The learning algorithm of the weights refers to that, the mean value of the N indices is first derived as m₀, the difference of square sᵢ=(mᵢ−m₀)² between each index and the mean value is then calculated, and the following target function is optimized through the stochastic gradient descent algorithm to obtain each weight wᵢ:

argmin_{w}Σᵢ₌₀^{N}wᵢ sᵢ;

s.t. Σᵢ₌₀^{N}wᵢ=1;∀wᵢ≥0.

This approach of acquiring the weights can assign a larger weight value to the majority consensus index, and a smaller weight value to the minority index disagreeing with the majority index. Therefore, the rationality of the combination of the indices is improved, such that the combined indices can more accurately measure the degree of closeness of the organizational relationship.

In some alternative implementations of this embodiment, the collaborative data includes at least one of: a mail, instant messaging collaboration log, a meeting collaboration log, or a project collaborative management log. The collaboration index includes at least one of: a number of mail collaborations, a number of people in the mail collaborations, a number of days for the mail collaborations, a number of instant messaging collaborations, a number of people in the instant messaging collaborations, a number of days for the instant messaging collaborations, a number of instant messaging conversations, a number of meetings, a duration of the meetings, an average number of participants in each meeting, a number of days for the meetings, a number of collaborative projects, a number of project collaborations, a number of people in the project collaborations, or a number of days for the project collaborations. Through different kinds of collaborative data and different collaboration indices, the degree of closeness of the organizational relationship is comprehensively measured, which provides scientific data support for the management and decision-making of the organizations.

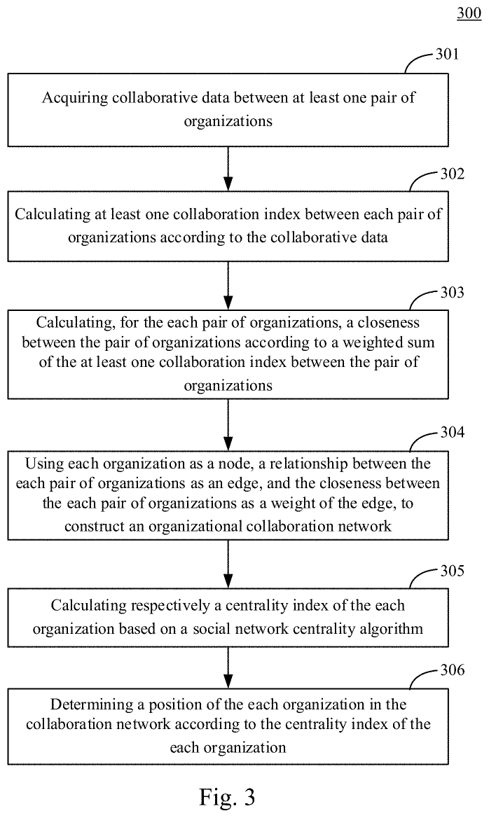

Further referring to FIG. 3, FIG. 3 illustrates a flow 300 of another embodiment of the method for constructing an organizational collaboration network. The flow 300 of the method for constructing an organizational collaboration network includes the following steps:

Step 301, acquiring collaborative data between at least one pair of organizations.

Step 302, calculating at least one collaboration index between each pair of organizations according to the collaborative data.

Step 303, calculating, for each pair of organizations, a degree of closeness between the pair of organizations according to a weighted sum of the at least one collaboration index between the pair of organizations.

Step 304, using each organization as a node, a relationship between each pair of organizations as an edge, and the degree of closeness between each pair of organizations as a weight of the edge, to construct an organizational collaboration network.

Steps 301-304 are substantially the same as steps 201-204, and thus will not be repeatedly described.

Step 305, calculating respectively a centrality index of each organization based on a social network centrality algorithm.

In this embodiment, Centrality is a concept commonly used in social network analysis (SNA), which is used to express the degree to which a point or a person in a social network is central to the whole network. The degree, when being represented by numbers, is called a centrality (i.e., a concept that the importance of a node in the network is determined by knowing the centrality of the node).

Different methods of measuring the centrality can be divided into, a degree centrality, a proximity centrality (or a closeness centrality), an intermediate centrality (a betweenness centrality), a pagerank centrality, an authority and hub centrality (hits), and the like. The calculation methods of the above centralities are all conventional methods in the prior art, and thus will not be repeatedly described.

Step 306, determining a position of each organization in the collaboration network according to the centrality index of each organization.

In this embodiment, the position of each organization in the collaboration network can be determined according to the above index. A larger degree value represents a larger number of organizations collaborating with the organization, a larger closeness value represents that the position of the organization is more central to the collaboration network, a larger betweenness value represents that the organization plays a role as a bridge in the collaboration network, and a larger pagerank and a larger hits represent a higher importance of the organization in the collaboration network.

Accordingly, the importance of each organization can be analyzed from the collaborative data. Also, the importance of the organization can be set in advance for verification. If the analysis result is different from the actual setting, it is required to re-plan the setting of the organization. For example, a best equipment and a largest number of people are provided for a department A. However, it is analyzed from the collaborative data that the importance of the department A is not high. Accordingly, the resource configuration for the department A is unreasonable, and it is required to perform re-planning and cut the resources of the department A.

It can be seen from FIG. 3 that, as compared with the embodiment corresponding to FIG. 2, the flow 300 of the method for constructing an organizational collaboration network in this embodiment reflects the step of analyzing the organizational collaboration network. Accordingly, the scheme described in this embodiment may provide organization managers with an organizational collaboration analysis and management tool, which can be applied to organization management scenarios such as an organization design and planning scenario, an organization diagnosis and evaluation scenario, and an organization operation scenario, which provides an automated organization evaluation and management tool for enterprise managers, thus providing scientific data support for the management and decision-making of the organizations.

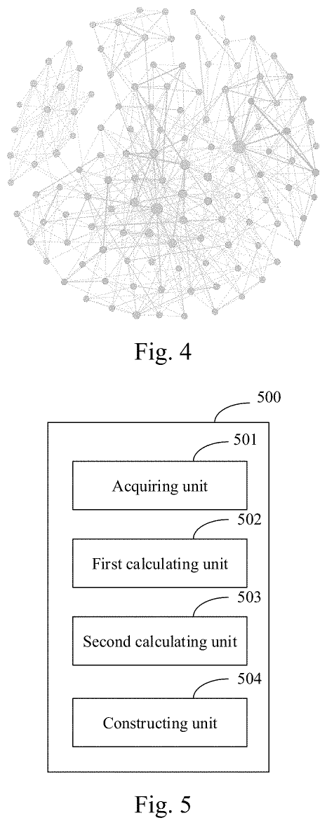

In some alternative implementations of this embodiment, the method further includes: retaining, by each organization, a predetermined number of organizational relationships in a descending order of degrees of closeness, to reconstruct an organizational collaboration network; and outputting a graph of the reconstructed organizational collaboration network. For a clear and intuitive display effect, each organization retains only top K closest organizational collaboration relationships, to reconstruct an organizational collaboration network. The graph of the network is constructed using social network visualization software (e.g., Gephi), an appropriate network layout is selected, and the styles of nodes and edges are adjusted. The effect drawing is as shown in FIG. 4.

A visual organizational collaboration network can be constructed, and thus, the relationship between different organizations can be clearly observed, which facilitates the analysis for the organizational collaboration network, thus reducing the labor input costs. An organizational collaboration network insight analysis report is given.

In some alternative implementations of this embodiment, the method further includes: dividing the at least one pair of organizations into different communities according to a community discovery algorithm. The organizations may be divided into different communities according to the community discovery algorithm such as Givan-Newman and Louvain. Organizations in the same community have strong cohesiveness, representing that the organizations in the community are very closely collaborated with each other. In the visual graph of the network, the organization nodes of different communities are displayed in different colors. Based on the organizational collaboration network, organizational collaboration insights can be provided for the managers to support the management and decision-making of the organizations.

Further referring to FIG. 5, as an implementation of the method shown in the above drawings, the present disclosure provides an embodiment of an apparatus for constructing an organizational collaboration network. The embodiment of the apparatus corresponds to the embodiment of the method shown in FIG. 2, and the apparatus may be applied in various electronic devices.

As shown in FIG. 5, an apparatus 500 for constructing an organizational collaboration network in this embodiment includes: an acquiring unit 501, a first calculating unit 502, a second calculating unit 503, and a constructing unit 504. Here, the acquiring unit 501 is configured to acquire collaborative data between at least one pair of organizations. The first calculating unit 502 is configured to calculate at least one collaboration index between each pair of organizations according to the collaborative data. The second calculating unit 503 is configured to calculate, for each pair of organizations, a degree of closeness between the pair of organizations according to a weighted sum of the at least one collaboration index between the pair of organizations. The constructing unit 504 is configured to use each organization as a node, a relationship between each pair of organizations as an edge, and the degree of closeness between each pair of organizations as a weight of the edge, to construct an organizational collaboration network.

In this embodiment, for specific processes of the acquiring unit 501, the first calculating unit 502, the second calculating unit 503 and the constructing unit 504 in the apparatus 500 for constructing an organizational collaboration network, reference may be made to step 201, step 202, step 203 and step 204 in the corresponding embodiment of FIG. 2.

In some alternative implementations of this embodiment, the apparatus 500 further includes a determining unit (not shown). The determining unit is configured to: calculate respectively a centrality index of each organization based on a social network centrality algorithm; and determine a position of each organization in the collaboration network according to the centrality index of each organization.

In some alternative implementations of this embodiment, the apparatus 500 further includes an outputting unit (not shown). The outputting unit is configured to: retain, by each organization, a predetermined number of organizational relationships in a descending order of degrees of closeness, to reconstruct an organizational collaboration network; and output a graph of the reconstructed organizational collaboration network.

In some alternative implementations of this embodiment, the apparatus 500 further includes a grouping unit (not shown). The grouping unit is configured to: divide the at least one pair of organizations into different communities according to a community discovery algorithm.

In some alternative implementations of this embodiment, the first calculating unit 502 is further configured to: generate, by each organization, one numerical value list for each collaboration dimension, the numerical value list representing collaboration index values of all organizations collaborating with each organization; and arrange the numerical value list of each organization in a descending order to obtain a ranking result, and normalize the ranking result to obtain the at least one collaboration index between each pair of organizations.

In some alternative implementations of this embodiment, the second calculating unit 503 is further configured to: calculate, for each pair of organizations, a mean value of each collaboration index between the pair of organizations, and calculate a difference of square of each collaboration index according to the mean value of each collaboration index; optimize a target function through a stochastic gradient descent algorithm to obtain a weight of each collaboration index, the target function being aimed to minimize a weighted sum of the difference of square of each collaboration index; and calculate the degree of closeness between each pair of organizations according to the weight.

In some alternative implementations of this embodiment, the collaborative data comprises at least one of: a mail, instant messaging collaboration log, a meeting collaboration log, or a project collaborative management log. The collaboration index comprises at least one of: a number of mail collaborations, a number of people in the mail collaborations, a number of days for the mail collaborations, a number of instant messaging collaborations, a number of people in the instant messaging collaborations, a number of days for the instant messaging collaborations, a number of instant messaging conversations, a number of meetings, a duration of the meetings, an average number of participants in each meeting, a number of days for the meetings, a number of collaborative projects, a number of project collaborations, a number of people in the project collaborations, or a number of days for the project collaborations.

In the technical solution of the present disclosure, the collection, storage, use, processing, transmission, provision, disclosure, etc. of the personal information of a user all comply with the provisions of the relevant laws and regulations, and do not violate public order and good customs.

According to an embodiment of the present disclosure, the present disclosure further provides an electronic device, a readable storage medium, and a computer program product.

An electronic device includes at least one processor, and a storage device in communication with the at least one processor. Here, the storage device stores instructions executable by the at least one processor, and the instructions are executed by the at least one processor, to enable the at least one processor to perform the method according to the flow 200 or 300.

A non-transitory computer readable storage medium stores a computer instruction. Here, the computer instruction is used to cause a computer to perform the method according to the flow 200 or 300.

A computer program product includes a computer program. Here, the computer program, when executed by a processor, implements the method according to the flow 200 or 300.

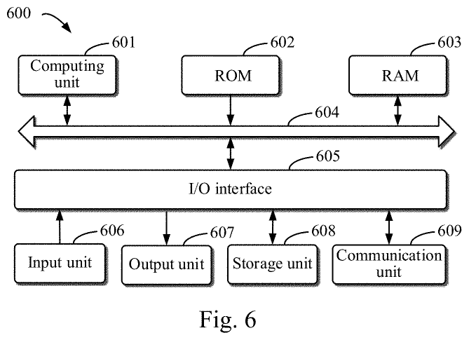

FIG. 6 is a schematic block diagram of an exemplary electronic device 600 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 6, the device 600 includes a computation unit 601, which may execute various appropriate actions and processes in accordance with a computer program stored in a read-only memory (ROM) 602 or a computer program loaded into a random access memory (RAM) 603 from a storage unit 608. The RAM 603 also stores various programs and data required by operations of the device 600. The computation unit 601, the ROM 602 and the RAM 603 are connected to each other through a bus 604. An input/output (I/O) interface 605 is also connected to the bus 604.

The following components in the device 600 are connected to the I/O interface 605: an input unit 606, for example, a keyboard and a mouse; an output unit 607, for example, various types of displays and a speaker; a storage device 608, for example, a magnetic disk and an optical disk; and a communication unit 609, for example, a network card, a modem, a wireless communication transceiver. The communication unit 609 allows the device 600 to exchange information/data with an other device through a computer network such as the Internet and/or various telecommunication networks.

The computation unit 601 may be various general-purpose and/or special-purpose processing assemblies having processing and computing capabilities. Some examples of the computation unit 601 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 601 performs the various methods and processes described above, for example, the method for constructing an organizational collaboration network. For example, in some embodiments, the method for constructing an organizational collaboration network may be implemented as a computer software program, which is tangibly included in a machine readable medium, for example, the storage device 608. In some embodiments, part or all of the computer program may be loaded into and/or installed on the device 600 via the ROM 602 and/or the communication unit 609. When the computer program is loaded into the RAM 603 and executed by the computation unit 601, one or more steps of the above method for constructing an organizational collaboration network may be performed. Alternatively, in other embodiments, the computation unit 601 may be configured to perform the method for constructing an organizational collaboration network through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, a distributed system server, or a server combined with a blockchain.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for constructing an organizational collaboration network, comprising:
acquiring collaborative data between at least one pair of organizations;
calculating at least one collaboration index between each pair of organizations according to the collaborative data;
calculating, for each pair of organizations, a degree of closeness between the pair of organizations according to a weighted sum of the at least one collaboration index between the pair of organizations; and
using each organization as a node, a relationship between each pair of organizations as an edge, and the degree of closeness between each pair of organizations as a weight of the edge, to construct the organizational collaboration network.

2. The method according to claim 1, further comprising:
calculating respectively a centrality index of each organization based on a social network centrality algorithm; and
determining a position of each organization in the collaboration network according to the centrality index of the organization.

3. The method according to claim 1, further comprising:
retaining, by each organization, a predetermined number of organizational relationships in a descending order of degrees of closeness, to reconstruct an organizational collaboration network; and
outputting a graph of the reconstructed organizational collaboration network.

4. The method according to claim 1, further comprising:
dividing the at least one pair of organizations into different communities according to a community discovery algorithm.

5. The method according to claim 1, wherein the calculating at least one collaboration index between each pair of organizations according to the collaborative data comprises:
generating, by each organization, one numerical value list for each collaboration dimension, the numerical value list representing collaboration index values of all organizations collaborating with each organization; and
arranging the numerical value list of each organization in a descending order to obtain a ranking result, and normalizing the ranking result to obtain the at least one collaboration index between each pair of organizations.

6. The method according to claim 1, wherein the calculating, for each pair of organizations, a degree of closeness between the pair of organizations according to a weighted sum of the at least one collaboration index between the pair of organizations comprises:
calculating, for each pair of organizations, a mean value of each collaboration index between the pair of organizations, and calculating a difference of square of each collaboration index according to the mean value of each collaboration index;
optimizing a target function through a stochastic gradient descent algorithm to obtain a weight of each collaboration index, the target function being aimed to minimize a weighted sum of the difference of square of each collaboration index; and
calculating the degree of closeness between each pair of organizations according to the weight.

7. The method according to claim 1, wherein the collaborative data comprises at least one of: a mail, an instant messaging collaboration log, a meeting collaboration log, or a project collaborative management log; and
the collaboration index comprises at least one of: a number of mail collaborations, a number of people in the mail collaborations, a number of days for the mail collaborations, a number of instant messaging collaborations, a number of people in the instant messaging collaborations, a number of days for the instant messaging collaborations, a number of instant messaging conversations, a number of meetings, a duration of the meetings, an average number of participants in each meeting, a number of days for the meetings, a number of collaborative projects, a number of project collaborations, a number of people in the project collaborations, or a number of days for the project collaborations.

8. An electronic device, comprising:
at least one processor; and
a storage device that stores instructions that, when executed by the at least one processor, cause the at least one processor to perform operations for constructing an organizational collaboration network, the operations comprising:
acquiring collaborative data between at least one pair of organizations;
calculating at least one collaboration index between each pair of organizations according to the collaborative data;
calculating, for each pair of organizations, a degree of closeness between the pair of organizations according to a weighted sum of the at least one collaboration index between the pair of organizations; and
using each organization as a node, a relationship between each pair of organizations as an edge, and the degree of closeness between each pair of organizations as a weight of the edge, to construct the organizational collaboration network.

9. The electronic device according to claim 8, the operations further comprising:
calculating respectively a centrality index of each organization based on a social network centrality algorithm; and
determining a position of each organization in the collaboration network according to the centrality index of the organization.

10. The electronic device according to claim 8, the operations further comprising:
retaining, by each organization, a predetermined number of organizational relationships in a descending order of degrees of closeness, to reconstruct an organizational collaboration network; and
outputting a graph of the reconstructed organizational collaboration network.

11. The electronic device according to claim 8, the operations further comprising:
dividing the at least one pair of organizations into different communities according to a community discovery algorithm.

12. The electronic device according to claim 8, wherein the calculating at least one collaboration index between each pair of organizations according to the collaborative data comprises:
generating, by each organization, one numerical value list for each collaboration dimension, the numerical value list representing collaboration index values of all organizations collaborating with each organization; and
arranging the numerical value list of each organization in a descending order to obtain a ranking result, and normalizing the ranking result to obtain the at least one collaboration index between each pair of organizations.

13. The electronic device according to claim 8, wherein the calculating, for each pair of organizations, a degree of closeness between the pair of organizations according to a weighted sum of the at least one collaboration index between the pair of organizations comprises:
calculating, for each pair of organizations, a mean value of each collaboration index between the pair of organizations, and calculating a difference of square of each collaboration index according to the mean value of each collaboration index;
optimizing a target function through a stochastic gradient descent algorithm to obtain a weight of each collaboration index, the target function being aimed to minimize a weighted sum of the difference of square of each collaboration index; and
calculating the degree of closeness between each pair of organizations according to the weight.

14. The electronic device according to claim 8, wherein the collaborative data comprises at least one of: a mail, an instant messaging collaboration log, a meeting collaboration log, or a project collaborative management log; and
the collaboration index comprises at least one of: a number of mail collaborations, a number of people in the mail collaborations, a number of days for the mail collaborations, a number of instant messaging collaborations, a number of people in the instant messaging collaborations, a number of days for the instant messaging collaborations, a number of instant messaging conversations, a number of meetings, a duration of the meetings, an average number of participants in each meeting, a number of days for the meetings, a number of collaborative projects, a number of project collaborations, a number of people in the project collaborations, or a number of days for the project collaborations.

15. A non-transitory computer readable storage medium, storing a computer instruction, wherein the computer instruction is used to cause a computer to perform operations for constructing an organizational collaboration network, the operations comprising:
acquiring collaborative data between at least one pair of organizations;
calculating at least one collaboration index between each pair of organizations according to the collaborative data;
calculating, for each pair of organizations, a degree of closeness between the pair of organizations according to a weighted sum of the at least one collaboration index between the pair of organizations; and
using each organization as a node, a relationship between each pair of organizations as an edge, and the degree of closeness between each pair of organizations as a weight of the edge, to construct the organizational collaboration network.

16. The medium according to claim 15, the operations further comprising:
calculating respectively a centrality index of each organization based on a social network centrality algorithm; and
determining a position of each organization in the collaboration network according to the centrality index of each organization.

17. The medium according to claim 15, the operations further comprising:
retaining, by each organization, a predetermined number of organizational relationships in a descending order of degrees of closeness, to reconstruct an organizational collaboration network; and
outputting a graph of the reconstructed organizational collaboration network.

18. The medium according to claim 15, the operations further comprising:
dividing the at least one pair of organizations into different communities according to a community discovery algorithm.

19. The medium according to claim 15, wherein the calculating at least one collaboration index between each pair of organizations according to the collaborative data comprises:
generating, by each organization, one numerical value list for each collaboration dimension, the numerical value list representing collaboration index values of all organizations collaborating with each organization; and
arranging the numerical value list of each organization in a descending order to obtain a ranking result, and normalizing the ranking result to obtain the at least one collaboration index between each pair of organizations.

20. The medium according to claim 15, wherein the calculating, for each pair of organizations, a degree of closeness between the pair of organizations according to a weighted sum of the at least one collaboration index between the pair of organizations comprises:
calculating, for each pair of organizations, a mean value of each collaboration index between the pair of organizations, and calculating a difference of square of each collaboration index according to the mean value of each collaboration index;
optimizing a target function through a stochastic gradient descent algorithm to obtain a weight of each collaboration index, the target function being aimed to minimize a weighted sum of the difference of square of each collaboration index; and
calculating the degree of closeness between each pair of organizations according to the weight.
